(19) United States
(12) Patent Application Publication
(10) Pub. No.: US 2019/0160321 A1
(43) Pub. Date: May 30, 2019

(54) ASSIST PROFILING AND DYNAMIC TORQUE GENERATION FOR BIOMECHANICAL ASSISTIVE DEVICE

(71) Applicant: STEERING SOLUTIONS IP HOLDING CORPORATION, Saginaw, MI (US)

(72) Inventors: Muzaffer Y. Ozsecen, Saginaw, MI (US); Owen K. Tosh, Saginaw, MI (US); Rakesh Mitra, Saginaw, MI (US); Zaki Ryne, Saginaw, MI (US); Prerit Pramod, Saginaw, MI (US)

(21) Appl. No.: 16/205,734

(22) Filed: Nov. 30, 2018

Related U.S. Application Data
(60) Provisional application No. 62/592,618, filed on Nov. 30, 2017.

(51) Int. Cl. A63B 21/00; A63B 24/00; A61H 3/00; H02P 6/08

(52) U.S. Cl. CPC A63B 21/00181; A63B 2225/50; A63B 24/0087; A61H 3/00; H02P 6/08; A63B 2024/0071; A61H 2003/007; A61H 2201/165; A63B 2230/605; A63B 2220/50; A63B 2220/808; A63B 2220/807; A63B 2220/806; A61H 2201/1215; A61H 2201/5035; A61H 2201/5038; A61H 2201/5061; A61H 2201/5064; A61H 2201/5079; A61H 2201/5084; A61H 2201/5097; A63B 2220/836; A63B 24/0062

(57) ABSTRACT

According to one or more embodiments, a biomechanical assistive device is described that generates and provide assist torque by detecting user intent. An example biomechanical assistive device includes a motor, and a controller that generates a torque command for providing assist torque using the motor based on a user activity being performed using the biomechanical assistive device. The controller determines a stride frequency based on a position signal indicative of a position of a joint of the biomechanical assistive device. The controller dynamically adjusts the torque command based on the stride frequency to generate a final torque command. The controller applies the final torque command to the motor.

### CROSS-REFERENCES TO RELATED APPLICATIONS

This patent application claims priority to U.S. Provisional Patent Application Ser. No. 62/592,618, filed Nov. 30, 2017, which is incorporated herein by reference in its entirety.

### BACKGROUND

The present application generally relates to a biomechanical assistive device, and particularly to providing assist profiling and dynamic assist torque generation for the biomechanical assistive device.

Exoskeletons are devices that can amplify a person's natural ability and improve their quality of life. In one or more examples, exoskeleton devices facilitate overcoming physical human limitations by amplifying human strength, endurance, and mobility potential. The exoskeleton devices are thus biomechanical assistive devices that may be worn by a user, for example worn in association with a joint in the body, to amplify or improve the functioning of that joint.

Exoskeleton devices can be classified as either passive or powered devices. A passive device typically cannot generate and deliver energy external to the user, rather a passive device helps the user employ his own muscle power more effectively. Passive devices can include springs, and can store potential energy and deliver it in addition to the human motion. One example of exoskeleton-based passive assist is passive gravity support where the exoskeleton supports part of the user's weight. However, the exoskeleton cannot contribute to raise the user's center of gravity, for example when getting up from a chair.

A powered exoskeleton device on the other hand generates and supplies energy to the user through external means (i.e. electrical, hydraulic, etc.), in one or more examples, in a continuous way, to help the user to elevate the center of mass of the body at one point or another by generating torque, for example using one or more actuators. The biomechanical assistive devices that are described herein are powered exoskeleton devices.

### SUMMARY

Technical solutions are described for addressing technical challenges with assistive devices, particularly effectively providing torque assist in wearable assistive devices, such as exoskeletons, based on detecting user intent during various motion activities.

According to one or more embodiments, a biomechanical assistive device is described that generates and provide assist torque by detecting user intent. An example biomechanical assistive device includes a motor, and a controller that generates a torque command for providing assist torque using the motor based on a user activity being performed using the biomechanical assistive device. The controller determines a stride frequency based on a position signal indicative of a position of a joint of the biomechanical assistive device. The controller dynamically adjusts the torque command based on the stride frequency to generate a final torque command. The controller applies the final torque command to the motor.

According to one or more embodiments, a computer program product for operating a biomechanical assistive device includes computer readable storage medium with computer executable instructions therein. The computer executable instructions cause a controller to generate a torque command for providing assist torque using a motor based on a user activity being performed using the biomechanical assistive device. The controller determines a stride frequency based on a position signal indicative of a position of a joint of the biomechanical assistive device. The controller dynamically adjusts the torque command based on the stride frequency to generate a final torque command. The controller applies the final torque command to the motor.

According to one or more embodiments a computer-implemented method for operating a biomechanical assistive device includes generating a torque command for providing assist torque using a motor based on a user activity being performed using the biomechanical assistive device. The method further includes determining a stride frequency based on a position signal of a joint of the biomechanical assistive device. The method further includes dynamically adjusting the torque command based on the stride frequency to generate a torque command. The method further includes applying the torque command to the motor.

These and other advantages and features will become more apparent from the following description taken in conjunction with the drawings.

### BRIEF DESCRIPTION OF THE DRAWINGS

FIG. 1 is a perspective view of an exemplary adjustable biomechanical assist device according to one or more embodiments;

FIG. 2 depicts an example controller 200 according to one or more embodiments;

FIG. 3 depicts a block diagram of the biomechanical assistive device in operation according to one or more embodiments;

FIG. 4 depicts a block diagram of an assist command generation for implementing a dynamic torque command adjustment according to one or more embodiments;

FIG. 5 depicts a block diagram of implementation of a nonlinear shaping function for computing a base assist torque command according to one or more embodiments;

FIG. 6 depicts an example of a velocity signal and resultant torque command according to one or more embodiments;

FIG. 7 depicts an example block diagram of a heel strike detection according to one or more embodiments;

FIG. 8 depicts example operational flow diagram for computing a heel strike limiting factor according to one or more embodiments;

FIG. 9 depicts example results of heel strike detection and damping factor computation according to one or more embodiments;

FIG. 10 depicts an example block diagram implementing stride frequency computation according to one or more embodiments;

FIG. 11 depicts a block diagram for implementing a dynamic torque adjuster according to one or more embodiments;

FIG. 12 illustrates a frequency and time response;

FIG. 13 depicts a block diagram for stand-to-sit assist generation and dynamic torque adjustment according to one or more embodiments;

FIG. 14 depicts a block diagram for sit-to-stand assist generation and dynamic torque adjustment according to one or more embodiments;

FIG. 15 depicts a controller torque profile for stand-to-sit and sit-to-stand modes according to one or more embodiments;

FIG. 16 depicts a block diagram for downstairs assist generation and dynamic torque adjustment according to one or more embodiments;

FIG. 17 depicts a block diagram for upstairs assist generation and dynamic torque adjustment according to one or more embodiments;

FIG. 18 depicts a block diagram of a control system according to one or more embodiments;

FIG. 19 depicts an operation flow diagram for blending a reactive torque command a predictive torque command according to one or more embodiments;

FIG. 20 depicts a flowchart of an example operation of the control system according to one or more embodiments;

FIG. 21 depicts an example block diagram of a vehicle that includes a steering system implementing one or more embodiments; and

FIG. 22 depicts a block diagram for generating a torque command in a system according to one or more embodiments.

### DETAILED DESCRIPTION

An exoskeleton, particularly, an active exoskeleton is a biomechanical assistive device that provides torque assist at a human joint, such as the hip joint. A biomechanical assistive device provides torque assist at a human joint, such as the hip joint. For operation of the assistive devices, the devices have to provide the appropriate amount of torque to assist with the user's activity. One way of providing such assist is done by detecting the user's current activity (e.g. walking, standing, sitting etc.), and have to measure characteristics of the human motion and balance in the activity so that the assistive devices can provide the appropriate amount of torque to assist with the activity.

A technical challenge exists for the assistive device to recognize the user's current activity (walking, standing, sitting, etc.) and further identify and record recording key motion parameters (indicators of the performance of the user) so that appropriate amount of assist torque can be generated and provided to the joint/user. To provide the assist torque, the biomechanical assistive device, along with identifying a user activity, has to identify a user intent during various motion activities. Accordingly, it is desirable to identify user intent when performing a user activity with a biomechanical assistive device, and to generate and provide corresponding assist torque to the user by the biomechanical assistive device.

Typically, to identify the user intent, additional sensors are added to the assistive device to measure and derive additional information about the activity for determining the user intent. Use of additional sensors (such as torque, myoelectric and foot switches, position sensors, etc.) not only add to the cost of the biomechanical device, but also introduce additional technical challenges. For example, myoelectric signals pose calibration problems when worn by different users, or when the user's skin conductance level change (sweating, poor connection, etc.); torque sensors may restrict the motion of the user to detect the intent, and in turn result in delaying the desired assist timing; and foot switches provide an accurate timing of heel strike, but are often damaged easily due to the high shear loads they operate under and the nature of their construction. Another consideration is the weight of the assistive device that increases with additional sensors being added onto the assistive device.

The technical solutions described herein address such technical challenges by facilitating the biomechanical assistive device to use a control architecture that uses exoskeleton position as the only input to deliver torque assist while still being intuitive to control by the user. The control architecture eliminates the need to use additional sensors for determining user activity and user intent, thus reducing processing and calibration of the additional sensors, which introduce considerable delay to the use of the assistive devices that cause inconvenience to the wearer. For example, the signals obtained from the types of sensors described above (torque, myoelectric, and foot switches) may require the wearer to perform special processing and calibrations before using the assistive device. By minimizing such processing and calibration, the technical solutions described herein improve the performance of the assistive device. Further, the technical solutions described herein reduce the computational resources spent on such processing and calibration of the sensors used for determining user activity and user intent, thus improving the efficiency of the assistive device.

The technical solutions described herein use embodiments directed to a hip-joint assistive device, however it will be appreciated that the technical solutions can be implemented in assistive devices used at other joints in a body. Further, several embodiments of the technical solutions described herein can be used in an exercise machine in which the exercise machine is wearable exoskeleton that resists one or more motions of the user. Alternatively, or in addition, in one or more examples, the technical solutions described herein can facilitate a standalone system (not wearable exoskeleton) that detects motion and provide resistance torques to the user.

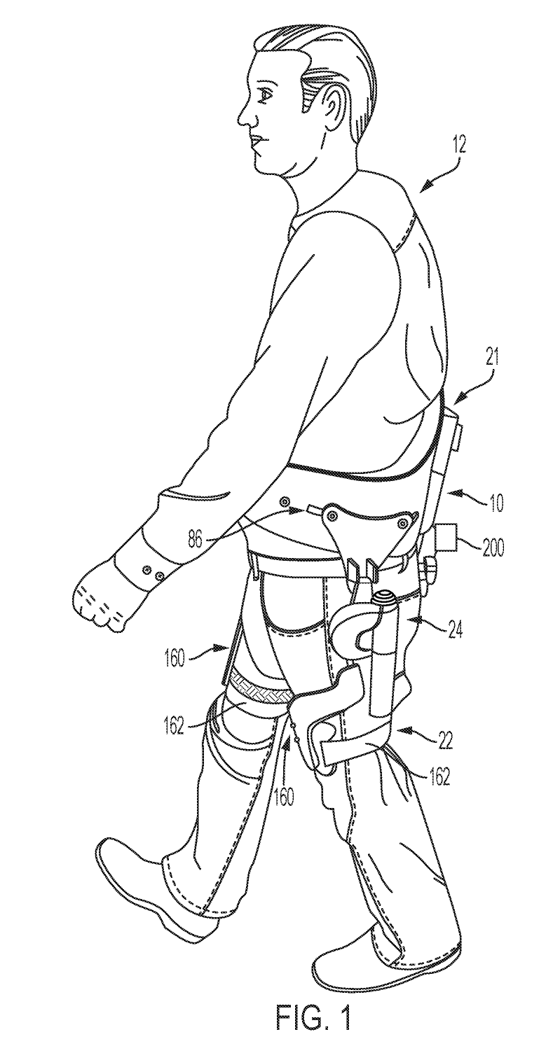

Referring now to the figures, FIG. 1 is a perspective view of an exemplary adjustable biomechanical assist device 10 according to one or more embodiments. Here, an environmental view of a powered assistive device 10 that is attachable to a user 12 is shown. The powered assistive device 10 is wearable by the user 12 to aid the user 12 in performing various movements, tasks, or to reduce the user's energy consumption during various movements. The powered assistive device 10 is mechanically grounded to a portion of the user 12 to aid in the transfer of torque by the powered assistive device 10 to the user 12. The powered assistive device 10 includes a lumbar support apparatus 21, at least one leg support 22, and an actuator 24.

The lumbar support apparatus 21 is configured as a torso brace that interfaces with the user 12. The lumbar support apparatus 21 is disposed about a user's waist proximate a user's hip region. The lumbar support apparatus 21 is configured to adjust overall human-exoskeleton interface stiffness through the use of various lumbar support types. The various lumbar support types permit the user 12 to adjust for comfort and load or torque transfer efficiency from the powered assistive device 10 to the user 12. The assistive device 10 further includes a controller 200. It should be noted that the depicted assistive device 10 is an example and that the technical solutions described herein are applicable to other types of biomechanical assistive devices too.

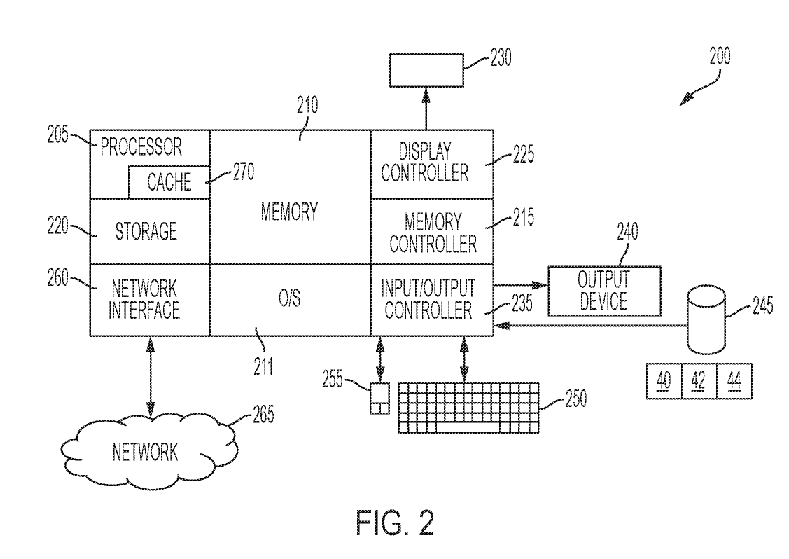

FIG. 2 depicts an example controller 200 according to one or more embodiments. The system 200 includes, among other components, a processor 205, memory 210 coupled to a memory controller 215, and one or more input devices 245 and/or output devices 240, such as peripheral or control devices, which are communicatively coupled via a local I/O controller 235. These devices 240 and 245 may include, for example, battery sensors, position sensors (gyroscope 40, accelerometer 42, GPS 44), indicator/identification lights and the like. Input devices such as a conventional keyboard 250 and mouse 255 may be coupled to the I/O controller 235. The I/O controller 235 may be, for example, one or more buses or other wired or wireless connections, as are known in the art. The I/O controller 235 may have additional elements, which are omitted for simplicity, such as controllers, buffers (caches), drivers, repeaters, and receivers, to enable communications.

The I/O devices 240, 245 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 205 is a hardware device for executing hardware instructions or software, particularly those stored in memory 210. The processor 205 may be a custom made or commercially available processor, a central processing unit (CPU), an auxiliary processor among several processors associated with the system 200, a semiconductor based microprocessor (in the form of a microchip or chip set), a macroprocessor, or other device for executing instructions. The processor 205 includes a cache 270, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 270 may be organized as a hierarchy of more cache levels (L1, L2, and so on.).

The memory 210 may include one or combinations of volatile memory elements (for example, random access memory, RAM, such as DRAM, SRAM, SDRAM) and nonvolatile memory elements (for example, ROM, erasable programmable read only memory (EPROM), electronically erasable programmable read only memory (EEPROM), programmable read only memory (PROM), tape, compact disc read only memory (CD-ROM), disk, diskette, cartridge, cassette or the like). Moreover, the memory 210 may incorporate electronic, magnetic, optical, or other types of storage media. Note that the memory 210 may have a distributed architecture, where various components are situated remote from one another but may be accessed by the processor 205.

The instructions in memory 210 may include one or more separate programs, each of which comprises an ordered listing of executable instructions for implementing logical functions. In the example of FIG. 2, the instructions in the memory 210 include a suitable operating system (OS) 211. The operating system 211 essentially may control the execution of other computer programs and provides scheduling, input-output control, file and data management, memory management, and communication control and related services.

Additional data, including, for example, instructions for the processor 205 or other retrievable information, may be stored in storage 220, which may be a storage device such as a hard disk drive or solid state drive. The stored instructions in memory 210 or in storage 220 may include those enabling the processor to execute one or more aspects of the systems and methods described herein.

The system 200 may further include a display controller 225 coupled to a user interface or display 230. In some embodiments, the display 230 may be an LCD screen. In other embodiments, the display 230 may include a plurality of LED status lights. In some embodiments, the system 200 may further include a network interface 260 for coupling to a network 265. The network 265 may be an IP-based network for communication between the system 200 and an external server, client and the like via a broadband connection. In an embodiment, the network 265 may be a satellite network. The network 265 transmits and receives data between the system 200 and external systems. In some embodiments, the network 265 may be a managed IP network administered by a service provider. The network 265 may be implemented in a wireless format, for example, using wireless protocols and technologies, such as WiFi, WiMax, satellite, or any other. The network 265 may also be a packet-switched network such as a local area network, wide area network, metropolitan area network, the Internet, or other similar type of network environment. The network 265 may be a fixed wireless network, a wireless local area network (LAN), a wireless wide area network (WAN) a personal area network (PAN), a virtual private network (VPN), intranet or other suitable network system and may include equipment for receiving and transmitting signals.

In one or more examples, using only two position sensors (one for each hip position), the technical solutions described herein facilitates the assistive device to recognize a new activity of a user with no additional user input and transition to a controller torque profile for the new activity within the predetermined duration. For example, the assistive device identifies different activities of the user such as sitting, standing, sit-to-stand, stand-to-sit, walking, staircase climbing, staircase descent, climbing up a ramp, climbing down a ramp, squatting, lifting, and other such activities, and facilitates near real-time transition from one activity (present activity) to another activity (new activity) that the user began without any explicit input from the user identifying the new activity. The technical solutions described herein thus facilitate an intuitive operation of the assistive device for the user, in turn improving the performance of the assistive device.

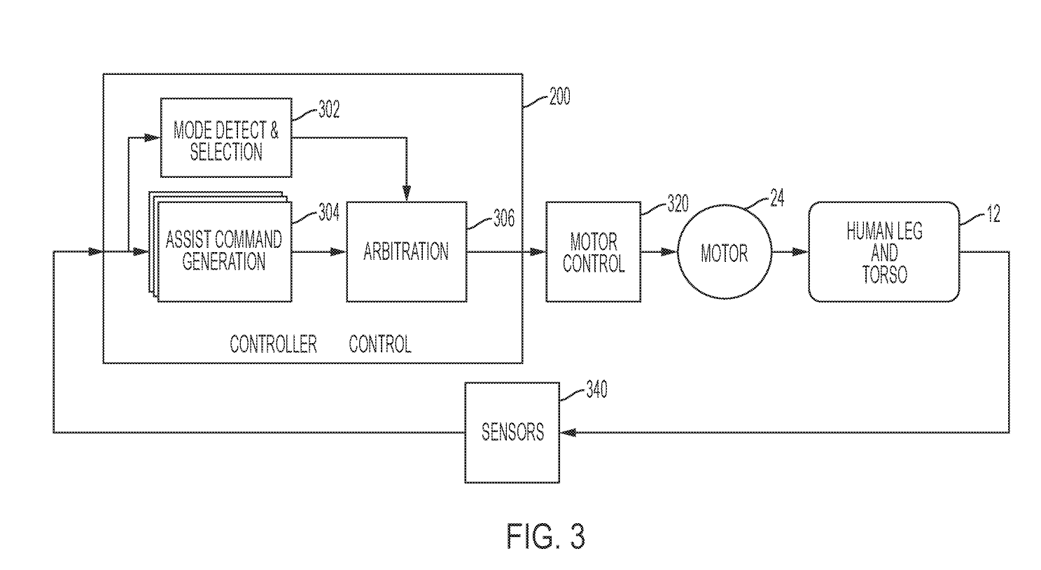

FIG. 3 depicts a block diagram of the biomechanical assistive device in operation according to one or more embodiments. Here, the controller 200 is shown to perform at least three operations of mode detection and selection 302, assist command generation 304, and arbitration 306.

The controller 200 performs such operations based on one or more instructions stored in a memory device of the controller 200, and/or based on one or more inputs. In one or more examples, the inputs can be received from the user 12 or any other personnel monitoring the user's activities when using the biomechanical assistive device 10. The inputs can be received in a wired or a wireless manner via one or more input interfaces.

The mode detection and selection 302 facilitates the controller 200 to automatically determine what activity the user 12 performing and an activity that the user 12 is about to perform based on input from one or more sensors 340. The sensors 340 can include position sensors, for example. In one or more examples, the biomechanical assistive device 10 operates as a (or using a) finite state machine. In such a case, each activity is considered a ‘state’ of the state machine and determining when to transition from one activity (state) to another is defined by the state machine. A finite state machine is broadly defined as a system with a finite number of discrete states, where each state has criteria to transition to one or more other states of the state machine. The state machine may be operated based on the sensor input, such as position of a hip, leg, or other types of joints of the user 12. For example, the mode detection and selection 302 identifies different activities of the user 12 such as sitting, standing, sit-to-stand, stand-to-sit, walking, staircase climbing, staircase descent, climbing up a ramp, climbing down a ramp, squatting, lifting and other such activities. The activities can be on an even or an uneven terrain.

The user activity that is detected is used by the assist command generation 304 to determine a torque command to be provided to a motor control system 320. For example, the assist command generation 304 can select a particular torque assist profile based on the detected user activity. The torque assist profile, in one or more examples, can provide a computation of the amount of torque to be generated to assist the user 12 to complete the user activity based on one or more sensor inputs. Further the user activity that is detected is used to determine a motor torque command to be provided to the motor control system 320. The motor control system 320 uses the input commands to operate the motor (actuator) 24 of the assistive device 10 to generate a corresponding amount of torque and/or displacement of the motor 24 to provide the assist to the user 12.

In one or more examples, the assist command generation 304 generates intuitive, variable, and adaptive torque assist commands using only position signal. For example, the assist command generation 304 can use separate and distinct controller torque profiles for different user activities, such as controller torque profiles for each of walking, sit to stand, stand to sit, sit, stand, climbing upstairs, climbing downstairs, climbing up a ramp, climbing down a ramp, squatting, lifting etc.

The assist command generation 304 uses the torque assist profiles and dynamic assist torque generation for timely and stable operation of the biomechanical assistive device 10 using (only) position signals. The desired torque output is tunable in amplitude and phase. The torque output is also adjustable and adaptive to the user's 12 pace. The technical solutions described herein further enhance the operations of the user 12 who is wearing the biomechanical assistive device 10 during activities where desired assist torque cannot be sensed as an input parameter but it correlates with a position related model.

In one or more examples, the mode detection and selection module 302 determines one or more modes of operation of the user 12 wearing the biomechanical assistive device 10. Based on the selected mode, the arbitration 306 determines which controller torque profile to use for generating the assist torque.

In one or more examples, the core input to generate torque commands are different states of position (i.e. position, velocity, acceleration). There exists a relative synchronization between the human torque, and controller torque profiles. The controller torque profiles are generated by processing one or more kinematic variables. The technical solutions described herein detect and use such a relationship by reshaping and shifting a controller torque profile for the user 12 to produce torque command based on the activity that the user 12 is performing. Further, by using the controller torque profile, the assist command generation 304 facilitates determining a desired torque trajectory and amplitude during a user activity, such as walking, based on a surrounding, such as a surface type. For example, the assist command generation 304 determines the desired torque trajectory and amplitude required during a normative walking cycle on a flat surface using an algorithm that is referred to as base assist torque command (i.e. BaseCmd). Base assist, in one or more examples, is not phase synchronized with human torque (input torque from the user 12). In one or more examples, for example where dynamic torque generation occurs before profiling, the base assist torque is phase synchronized with the human torque.

The torque command can be generated by using a scaled version of position, velocity, and/or acceleration, and using linear and nonlinear shaping functions of the one or more of these signals. An example of nonlinear function that can be deployed by the assist command generation 304 is a power function with a normalization factor.

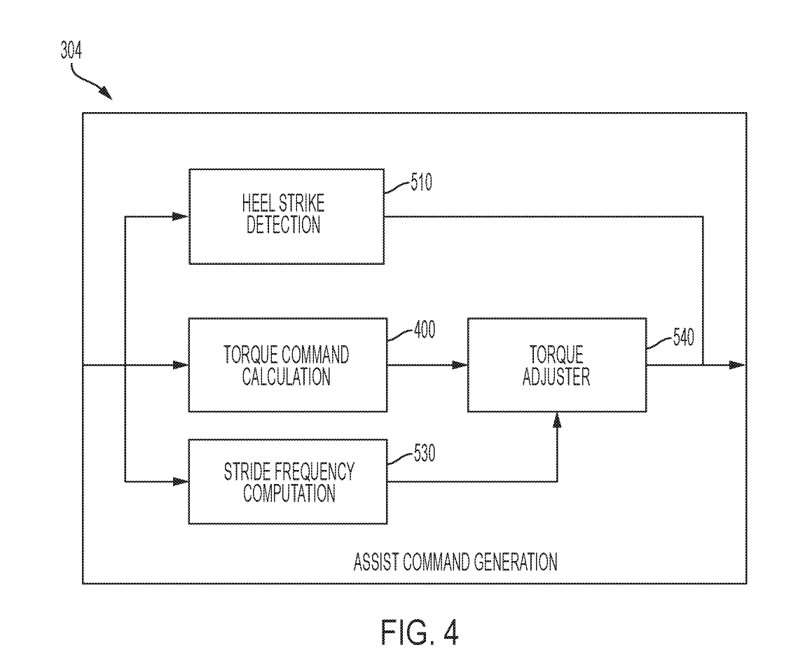

FIG. 4 depicts a block diagram of an assist command generation for implementing a dynamic torque command adjustment according to one or more embodiments. In FIG. 4, the assist command generation 304 is depicted to include one or more different operative blocks. It is understood that the depicted blocks are for explanation herein, and that in one or more examples, the assist command generation 304 can include additional, fewer, or different operative blocks than those depicted.

The assist command generation 304 includes a heel strike detection 510. Heel strike is a natural part of the gait cycle. However, when heel strike occurs it disturbs the synchronization between the torque and velocity profiles for transfer functions based on kinematic information. Therefore, heel strike event has to be compensated for by the biomechanical assistive device 10 by adjusting the torque command.

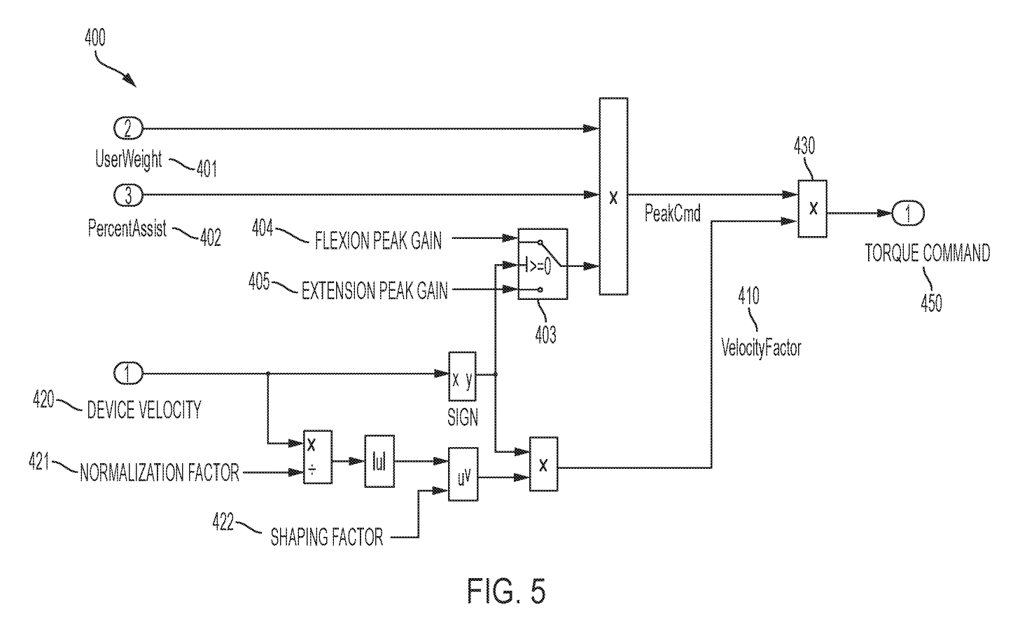

FIG. 5 depicts a block diagram of implementation of a nonlinear shaping function for computing a base assist torque command according to one or more embodiments. The output of the nonlinear shaping function is referred to as a “velocity factor” 410 in the illustration. Computing the velocity factor 410 is based on a velocity 420 of the biomechanical assist device 10. The velocity factor 410 shaping function forms a “weightless” profile of the base torque command 450 that is output in this case. The controller torque profile in this case is based on one or more factors such as the user's weight 401, base percentage assist values 402, and peak gains 403. The user's weight 401 is obtained by user input in one or more examples.

The values of base percentage assist 402 and peak gains 403 are configurable values that are predetermined prior to the computation is performed. These values facilitate to perform further scaling based on user's weight, user's choice of percent assist, and flexion and extension factors.

By multiplying (430) the result of the weightless base torque command with user's weight 401, base percentage assist values 402, and peak gains 403, the final base command torque assist value 450 is computed. In this case the shaping is done with the velocity factor 410 being a scaling factor for the generated controller torque profile. The velocity based shaping can be expressed as follows,

$${x}_{factor} = sign ( {ω}_{exo} ) {( \vert \frac{{ω}_{exo}}{a} \vert )}^{b}$$

Here, ωₑₓₒ is an angular velocity 420 of a joint of the biomechanical assist device 10, a is normalization factor 421 and b is shaping factor 422. Normalization factor a defines the velocity value in which the gain should be 1. The shaping factor b adjusts the rate of change of gain as the input signal (velocity) starts to deviate from the normalization value. For example, if b is equal to 1, the relationship between velocity and torque command is linear, whereas if b is between 0 and 1 it changes in a nonlinear manner, whereas the normalization speed gain is still equal to 1. If b is equal to 0, the command is constant for every velocity value except 0. For negative values of the shaping factor b, the torque command reduces as the velocity increases. Accordingly, a linear or nonlinear relationship is created by selecting the shaping factor.

User's weight 401 and percent assist 402 values are adjusted for each user 12 to provide torque assist amplitudes appropriate to their mobility needs. Additionally, flexion peak gain 404 and extension peak gain 405 are factors that define peak torque command of the base controller torque profile during a leg swing (Flexion) and stance (Extension) phases of gait for the user 12. The flexion peak gain 404 and extension peak gain 405 are computed as follows:

$$\begin{matrix}{x}_{{flexion}_{factor} / {extension}_{factor}} = \begin{matrix}{flexion}_{factor} & if sign ( {ω}_{exo} ) > 0\end{matrix} \\ = \begin{matrix}{extension}_{factor} & if sign ( {ω}_{exo} ) < 0\end{matrix}\end{matrix}$$

Thus, the final base torque command 450 for is obtained by combining all the aforementioned factors and is expressed as,

T_{command}_{_}_{final}=(W_{user-weight})·(% assist)·(x_{factor})·(x_{flexion}_{_{factor}}_{/extension}_{_{factor}})

The above equation depicts a torque command generated for walking activity. In one or more examples, the nonlinear shaping function described herein can dynamically transform a position, velocity, and/or acceleration to determine torque command at runtime. The nonlinear shaping function can transform the input signal (e.g. hip velocity) into a natural controller torque profile form. For example, depending on the factors one chooses to implement, the nonlinear shaping function is used to magnify or reduce the impact magnitude of the input signal.

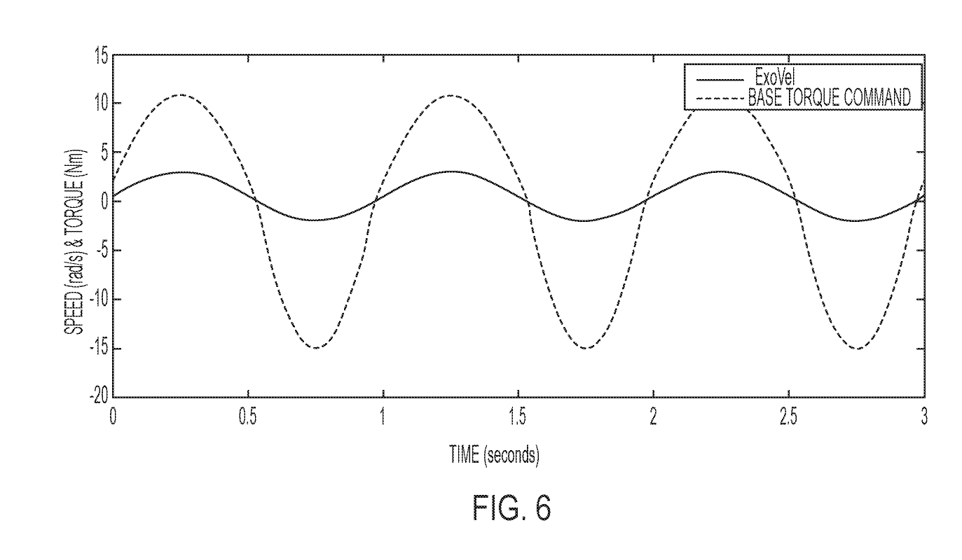

FIG. 6 depicts an example of a velocity signal and resultant torque command according to one or more embodiments. The nonlinear shaping function depicted in this example modifies the base torque by expanding the peak torque occurrence time and fastening the transition between torque values around zero. A torque command is generated using the modified torque value to provide a corresponding amount of assist torque.

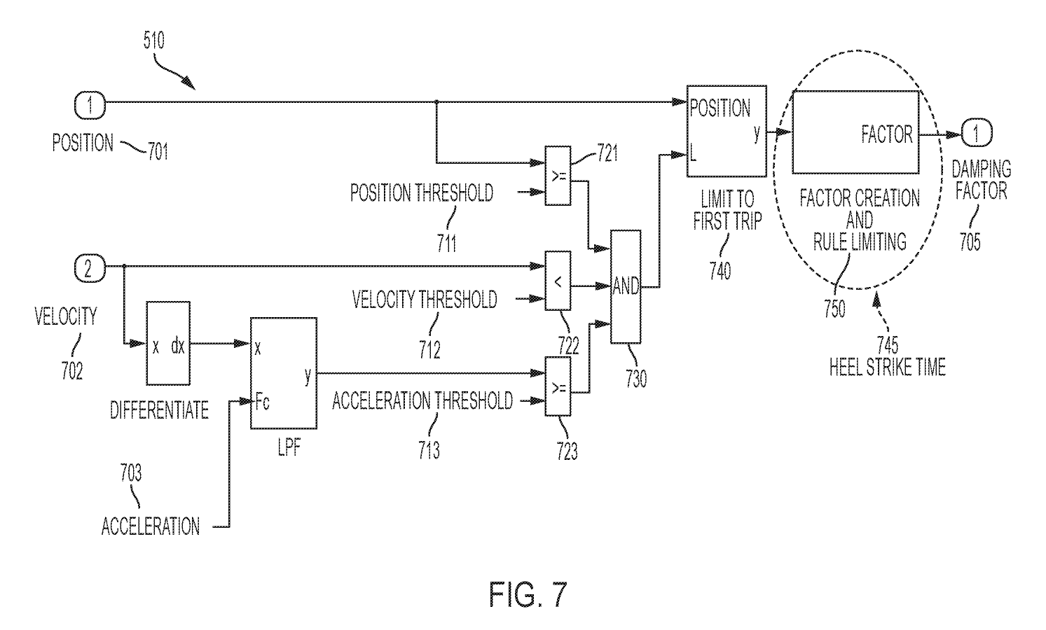

FIG. 7 depicts an example block diagram of a heel strike detection according to one or more embodiments. The heel strike detection 510 detects the duration of heel strike 745 by observing the position 701, velocity 702, and acceleration 703 and dampens the resultant assist torque for an adjustable settling time and gradually goes back to the original torque when disabled. The heel strike detection 510 generates a damping factor 705 that can be used to scale the torque command 450.

The heel strike detection is performed by comparing the position 701 with a position threshold 711 (721), the velocity 702 with a velocity threshold 712 (722), and the acceleration 703 with an acceleration threshold 713 (723). The results of the comparisons are combined using a logical operation (730). In one or more examples, the logical operation is an AND operation that generates a BOOLEAN (0/1) value as output based on the combination of the comparison results.

The output of the logical operation can be as follows:

L=Logical Operation((pos≥Tₚₒₛ),(vel<Tᵥₑₗ),(acc≥T_{acc}))

Here, Tₚₒₛ, Tᵥₑₗ, and T_{acc}, are the thresholds for position, velocity, and acceleration respectively. For example, in the case where the logical operation is an AND operation, the value of L is 1 when all three comparisons shown above are true, and 0 otherwise. The position signal 701 is multiplied by the output L using a limit block (740). The resulting output, the heel strike duration 745, is forwarded to a factor creation block (750) that inverts the signal and applies an adjustable rate limit, which computes a damping factor to be multiplied with the base torque command (Reactive Module).

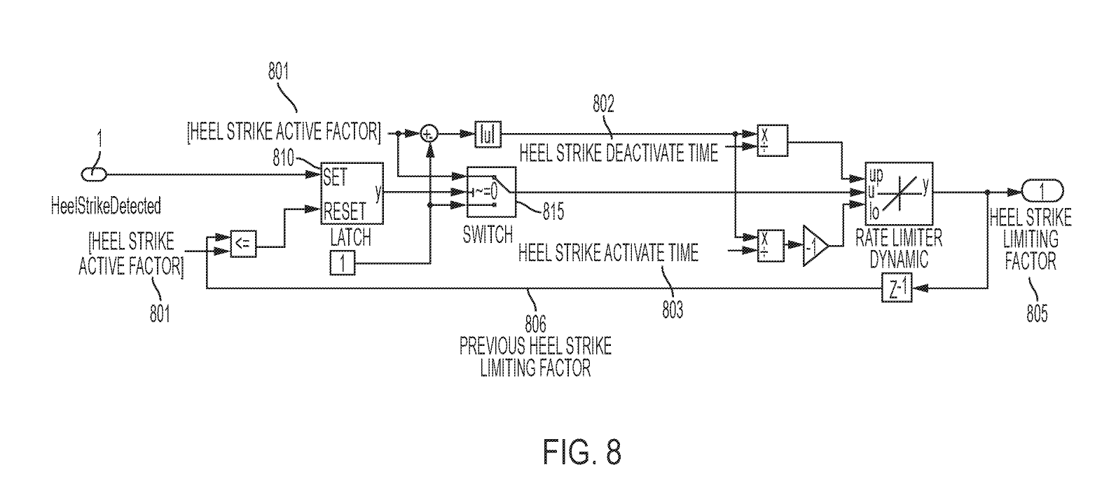

FIG. 8 depicts example operational flow diagram for computing a heel strike limiting factor according to one or more embodiments. When a heel strike is detected, latch 810 adjusts a state of a switch 815, either ON or OFF. In conjunction, a predetermined calibrate-able heel strike active factor 801 is used to adjust the state of the switch 815. The heel strike active factor 801 is compared with a previous output heel strike limiting factor 806, and the latch 810 is reset based on the comparison. In one or more examples, the reset is performed when the heel strike active factor 801 exceeds the previous heel strike limiting factor 806. Further, the heel strike active factor 801 is scaled down by dividing it either by a heel strike deactivate time 802, or a heel strike activate time 803. The scaled down values of the heel strike active factor 801 are used to limit the heel strike damping factor and output the heel strike limiting factor 806.

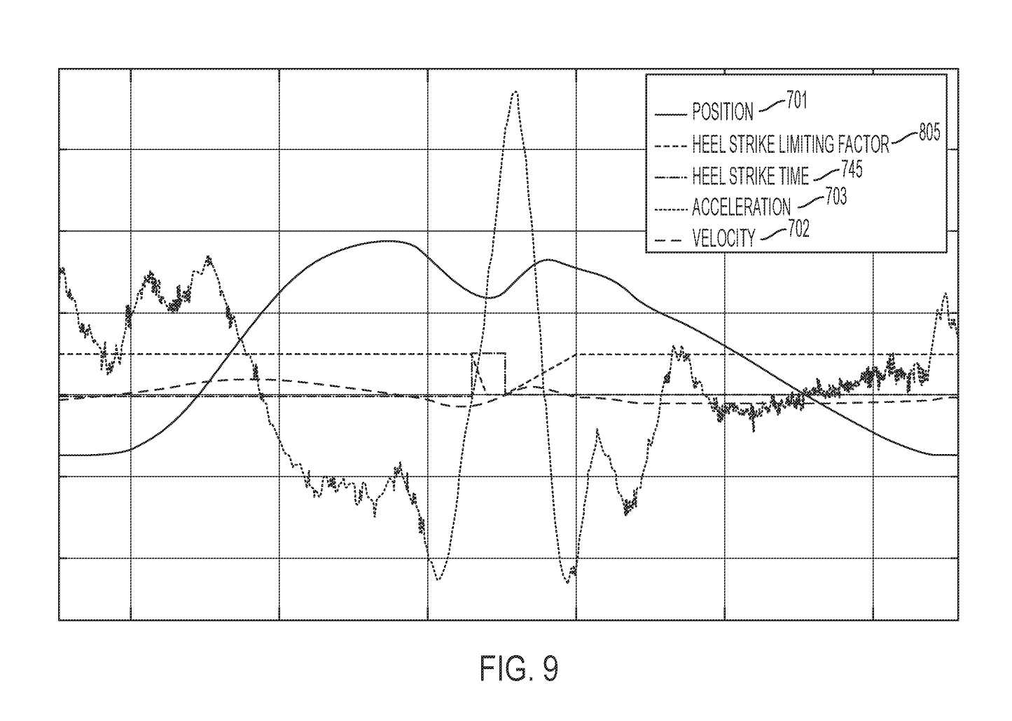

FIG. 9 depicts example results of heel strike detection and damping factor computation according to one or more embodiments. It can detect the heel strike event only using the position sensor 340 measurement while still delivering assist torque. The velocity and acceleration signals are computed using the position measurement from the position sensor 340. For example, the position measurement can be differentiated to compute the velocity 702, and the velocity computations are differentiated to compute the acceleration 703. The heel strike event, after being detected is tunable to provide the desired controller torque profile. The heel strike limiting factor 805 is based on the logical output L.

Referring to FIG. 4, the assist command generation 304 further includes a stride frequency computation 530. Stride frequency is the occurrence rate of each stride every second (in Hertz [Hz]), which can also be represented as the inverse of the last stride period.

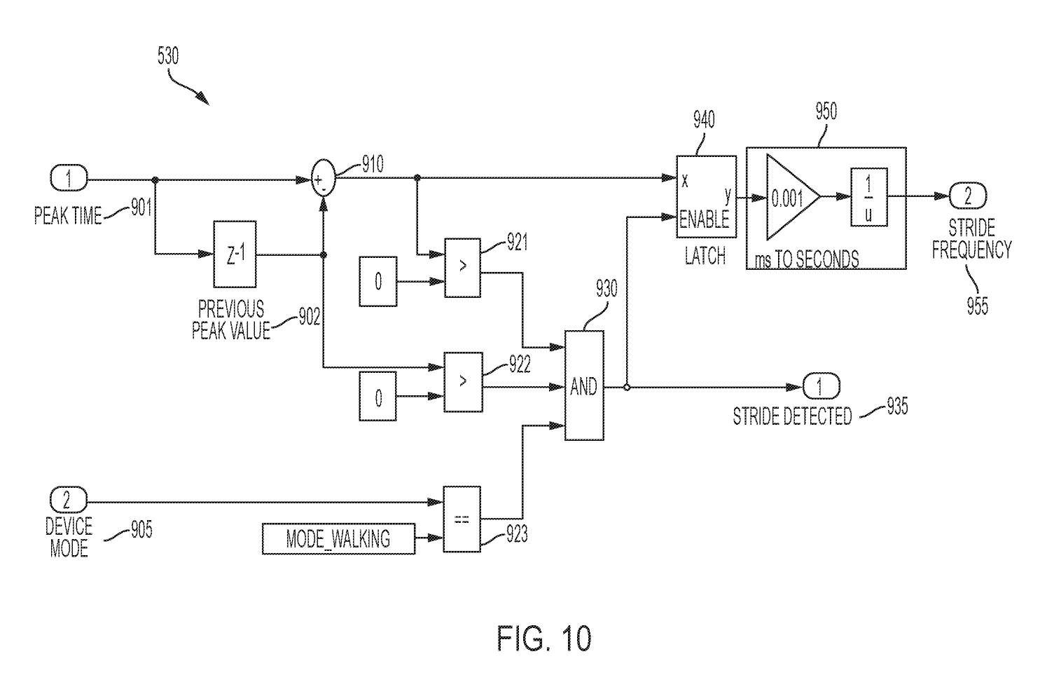

FIG. 10 depicts an example block diagram implementing stride frequency computation according to one or more embodiments. Timestamps of respective local peaks 901 in the position measurement signal from the position sensor 340 (i.e. Peak time) are reported by using a peak finding algorithm. Timestamp of a reported peak is compared with previously stored time value of a peak 902 and a difference between time (910) is calculated. When the time difference (910) in successive peaks is a positive value and the user mode is walking, a “Stride” detect flag is generated and the stride frequency output value is calculated (950). Whether the user is walking is determined based on a mode 905 of the device as is detected by the mode detection and selection 302 and comparing (923) with the walking mode. Further, the difference between the successive peaks is compared (921) with zero value. In one or more examples, it is ensured that the peaks themselves are not zero (922).

If the above conditions are satisfied, checked using an AND block 930, the computed difference between the successive peaks is stored, for example, using a latch block 940. The output of the AND block 930 is used as an enable signal to indicate that the latch block 940 is to store the input value (difference). Further, the stored value of the difference is converted (950) to a stride frequency value (Hz). The computed stride frequency 955 can be used as input to a dynamic adjustment as operation frequency. In one or more examples, the stride frequency 955. The result of the AND block 930 is output as a stride detection flag 935 to indicate whether a stride is detected.

Referring back to FIG. 4, an adaptive dynamic torque adjuster 540 matches the command profile that is generated during the base command calculation 400 to human intention (human torque) based on the velocity signal. This can be accomplished by changing the time response of the actuator 24, and hence effectively shifting the controller torque profile over time. The phase angle of the desired torque command, generated to match user motion (i.e. timing of assist) is tunable.

Desired torque adjuster phase provides a shift to modify gait imperfections and provide intuitive torque assist. For example, motion of human leg can be augmented by adding perturbations based on the gait cycle (which may be modeled from 0-to-100%) where 100% gait cycle is the final value of the instantaneous stride period divided by the maximum value of the stride period for that step. This variable correlates with the leg oscillation frequency. Phase adjustment at any point of the torque command produces an augmentation profile.

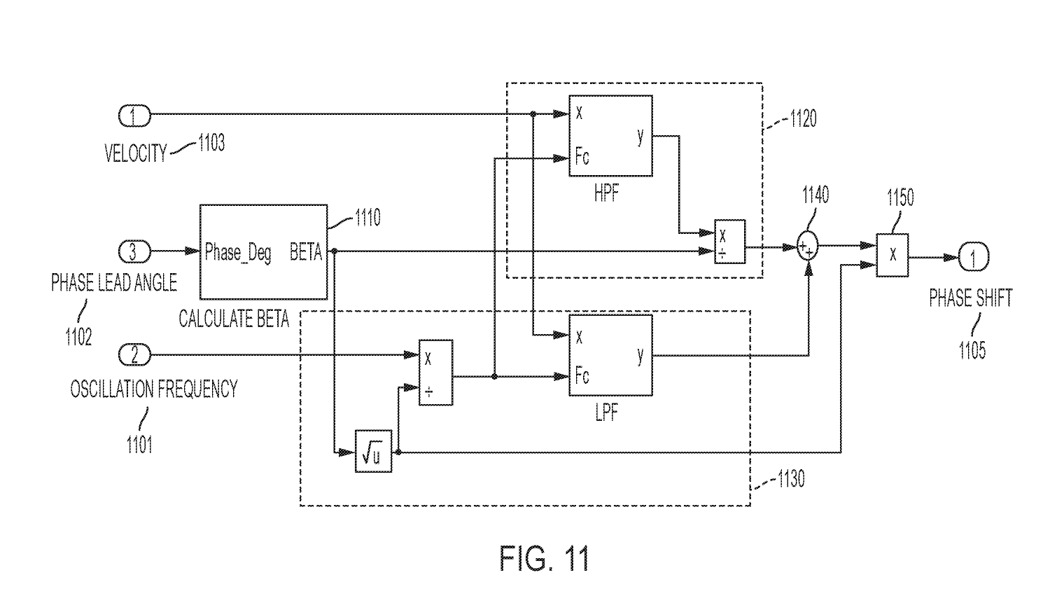

FIG. 11 depicts a block diagram for implementing a dynamic torque adjuster according to one or more embodiments. The depicted implementation is of a reactive dynamic torque adjuster that works with the velocity 1103 of the assistive device 10 as input (x). Below is an equation based representation of dynamic torque adjuster, which only modifies the augmentation timing implemented in the assistive device 10. A transfer function for the dynamic torque adjuster 540, in one or more examples, is:

$$H ( s ) = \frac{1}{β} \frac{( s + \frac{1}{2} )}{( s + \frac{1}{β τ} )}$$

Here:

$$β = \frac{1 - sin θ}{1 + sin θ} , \\ τ = \frac{1}{2 π f \sqrt{β}} ;$$

θ=Required phase lead angle in radians; and
f=Frequency at which phase lead is required.

The beta calculation (1110) computes the β using the input phase lead angle 1102. The oscillation frequency (f) is based on the stride frequency 955. Further, a numerator calculation 1120 is depicted that computes the numerator of the transfer function.

n, and a denominator calculation 1130 is depicted that computes the denominator of the transfer function using the β. A ratio (1140) of the computed numerator and the denominator is further multiplied by a reciprocal of \sqrt{β} to compute the phase shift 1105 for the torque command 450.

The magnitude at frequency f is given by:

$$\vert H ( ω ) \vert = \frac{b}{a} \frac{1}{{b}^{2} + {ω}^{2}} \sqrt{( ab + {ω}^{2} ) + {( b ω - a ω )}^{2}}$$

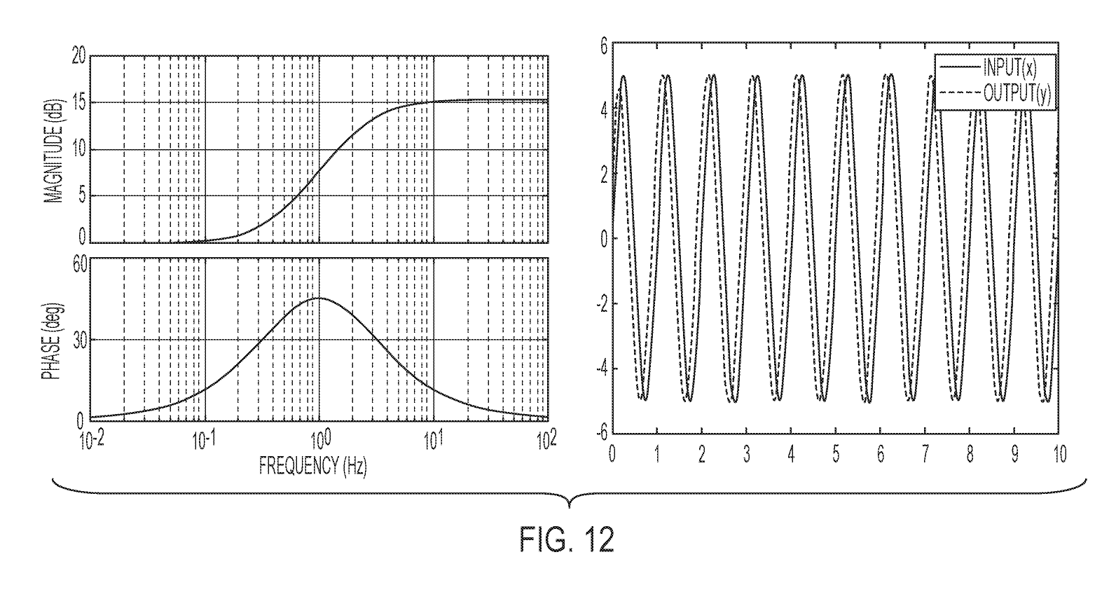

Here, ω=2πf. The frequency and time response of the above signal is shown in FIG. 12. Here, f is the actual operation frequency, which is resultant of movement of the user 12; and a and b are tunable parameters that change the performance of the assistive device 10 by changing the desired frequency of the filter based on a selection from the user 12. In one or more examples, a and b also define the zero and pole of the lead-lag compensator, which is represented herein as a highpass and/or a lowpass filter—in other words, a is the zero and b is the pole of the ideal lead-lag compensator.

In one or more examples, to implement the torque adjuster 540 in a microcontroller, a discretization method can be used. An example technique for s to z domain mapping is as follows:

$$s = \frac{ω}{tan ( \frac{ω {T}_{s}}{2} )} \frac{1 - {z}^{- 1}}{1 + {z}^{- 1}}$$

The above discretization method minimizes the frequency response deviation of the digital filter from its analog equivalent at the critical frequency. It should be understood that other transformation methods can also be used for the s to z domain mapping.

In one or more examples, a predictive dynamic torque adjuster 540 is used. The predictive dynamic torque adjuster 540 works with stride frequency 955 as input. In this case, a stride frequency confidence is used to modulate output of the dynamic torque adjuster 540. The output phase and amplitude is a function of ground speed of the assistive device 10 and gait cycle.

Stride frequency is calculated based on one or more detected events in the user's stride. In this embodiment, three events are used: peak flexion position, peak extension position, and detection of heel strike over the user's last stride. Each of these events are validated in a closed window, and the average of all valid signals is computed as the instantaneous stride frequency.

A confidence value, representing the perceived validity of the stride frequency calculation, is computed based on the number of valid events used in the average calculation, as well as the standard deviation of the valid signals. In one or more examples, the confidence is also modulated by a temporal comparison of events, with confidence increasing as deviation decreases.

User gait cycle is calculated from the stride frequency and detected events in conjunction with an internal timer. Using these values, an estimated gait cycle progression is calculated as a domain separate from time or position. This gait cycle progression is then used as the basis of the predictive dynamic controller torque profile generation. The predictive dynamic torque adjuster can be programmed to provide torque commands independent of the user hip velocity. A number of different sensors or methods can be used to establish events and calculate the period of events. After an event period that correlates with the motion is detected, a timer than is setup to be used as the input to a lookup table. This lookup table can be programmed to deliver the desired controller torque profile. In which the table is constructed by gait cycle as an input and torque command as an output. The output torque command can further be regulated by both stride frequency and stride confidence.

The lookup table in this embodiment is selected by the user from a predefined set of tables or adjustable tables that represent the desired controller torque profile as a function of gait cycle. The lookup table can have additional dimensions that further allow adjustment of controller torque profiles based on dynamic parameters. In this embodiment, an additional lookup table is present to scale the controller torque profiles based on walking speed over ground. Other embodiments can include controller torque profile adjustments based on uneven terrain, ramped surfaces, and other topography. The lookup table described here is further displayed in a tablet, smartphone, computer or other visual interaction format with a graphical user interface to receive the user's selection and provide relevant information regarding the controller settings.

In addition to the lookup table that defines controller torque profiles, users can select variety of other tunable parameters. These parameters include, weight, height level of assist required, and “comfort” feel. Comfort feel is adjusted by altering the time response of the system using the predictive and reactive segments of the controller previously described.

Alternatively, or in addition, the controller 200 can include both, the reactive dynamic torque adjuster 540 and the predictive dynamic torque adjuster 540. The controller 200 switches between the two torque adjuster based on whether the assistive device 10 is in a transient state of walking or a steady state of walking. For example, if a high stride frequency variability is determined, the controller 200 determines that the assistive device 10 is in a transient mode and uses the reactive dynamic torque adjuster 540. Else, if the controller 200 determines a low stride frequency variability, the assistive device 10 is deemed to be in a steady state. In such a case, the controller uses the predictive dynamic torque adjuster.

It should be noted that in one or more examples, the predictive torque adjuster and the reactive torque adjuster can be implemented using the same circuitry, such as a processor using different input values and performing different computations. Accordingly, in such cases, based on the determination of the operating mode of the assistive device 10, the controller 200 switches the dynamic torque adjuster 540 to operate as the reactive dynamic torque adjuster or the predictive dynamic torque adjuster.

The above techniques can be used for computing an amount of assist torque to provide to the user 12 during walking mode, and for generating the corresponding torque command. In one or more examples, the biomechanical assistive device 10 provides assist torque during sit-to-stand and stand-to-sit modes, and stair ascent and stair descent modes in addition to the walking mode. For both of these modes, the controller torque profile is selected to provide bidirectional controller torque profile. In bidirectional controller torque profiles, the torque command 450 is represented as a coiling spring to help work against gravitational forces during sit-to-stand and stand-to-sit transitional movements. Feel of the assistive device 10 is smoothened by blending position and velocity of the assistive device 10 (based on the position sensor outputs), to provide assist torque only if the user 12 is moving, while maintaining intuitiveness.

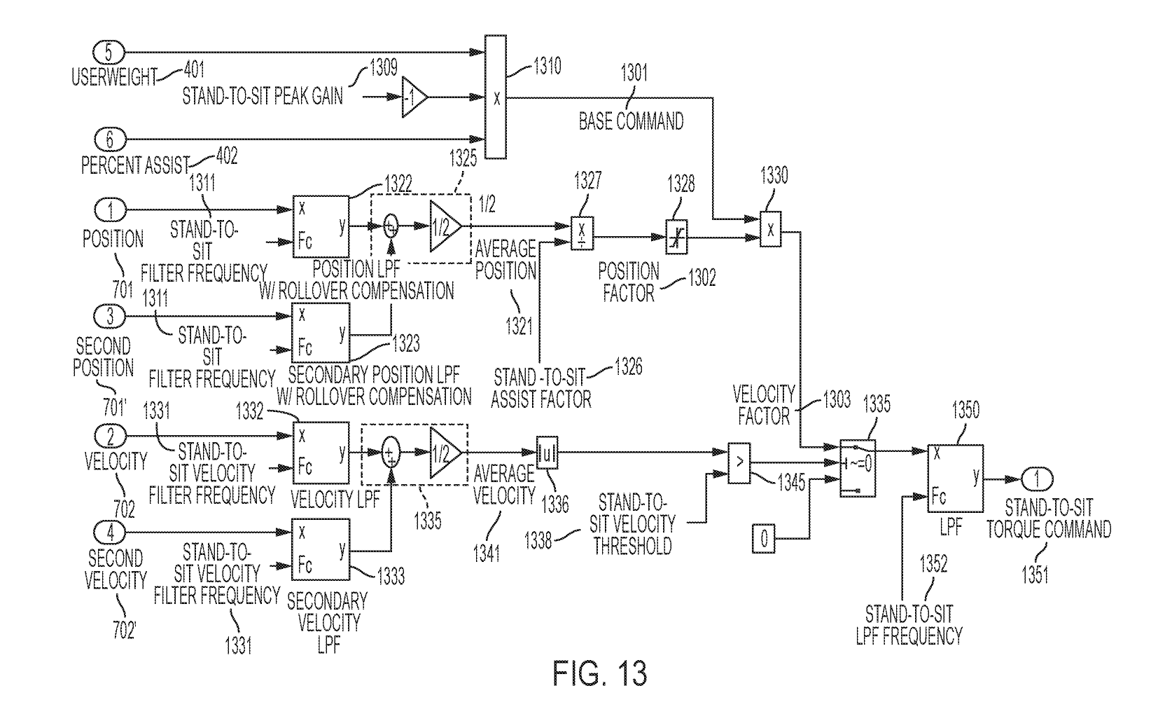

FIG. 13 depicts a block diagram for stand-to-sit assist generation and dynamic torque adjustment according to one or more embodiments. In the stand-to-sit mode, a base command (BaseCmd) 1301 is computed using a multiplier (1310) using the user's weight 401, percent assist 402 factor and a stand-to-sit peak gain 1311 for the stand-to-sit mode.

Further, a position factor 1302 is computed based on a first position 701 of a first joint and a second position 701′ of a second joint of the assistive device 10. The position factor 1302 is based on an average position 1321 computed using the first position 702 and the second position 701′. The average position 1321 is computed (1325) after filtering the first position 701 and the second position 701′ using low pass filters (1322, 1323). The low pass filters (1322, 1323) use a predetermined stand-to-sit filter value 1311 when filtering the first position 701 and the second position 701′. The average position 1321 is divided (1327) by a predetermined stand-to-sit assist factor 1326 to compute the position factor 1302. The position factor 1302 is saturated (1328) in one or more examples. The position factor 1302 is multiplied (1330) with the base command 1301.

The result of the multiplication (1330) is used to generate a stand-to-sit torque command 1351 based on a velocity factor 1303. The velocity factor 1303 is based on average velocity 1341 computed using a first velocity 702 of the first joint and a second velocity 702′ of the second joint. The average velocity 1341 is computed (1335) after filtering the first velocity 702 and the second velocity 702′ using low pass filters (1332, 1333). In one or more examples, an absolute value (1336) of the average velocity 1341 is computed and compared (1345) with a stand-to-sit velocity threshold 1338. The result of the comparison is used as the velocity factor 1303. The velocity factor is, accordingly, a BOOLEAN value i.e. 0 or 1.

If the velocity factor 1303 is 1, i.e. the average velocity 1341 is greater than the threshold 1338, the multiplication result of the position factor 1302 and the base torque command 1301 is filtered (1350) to compute the stand-to-sit torque command 1351. The filtering (1350), in one or more examples, is a low pass filter (LPF) using a stand-to-sit LPF frequency 1352.

If the velocity factor 1303 is 0 (1355), i.e. the average velocity 1341 is not greater than the threshold 1338, a 0 (zero) is input to the LPF 1350, resulting in a 0 assist torque for stand-to-sit activity.

Accordingly, for the stand-to-sit mode, the torque assist is generated based only on position because, as the user 12 approaches sitting he/she needs more assist torque.

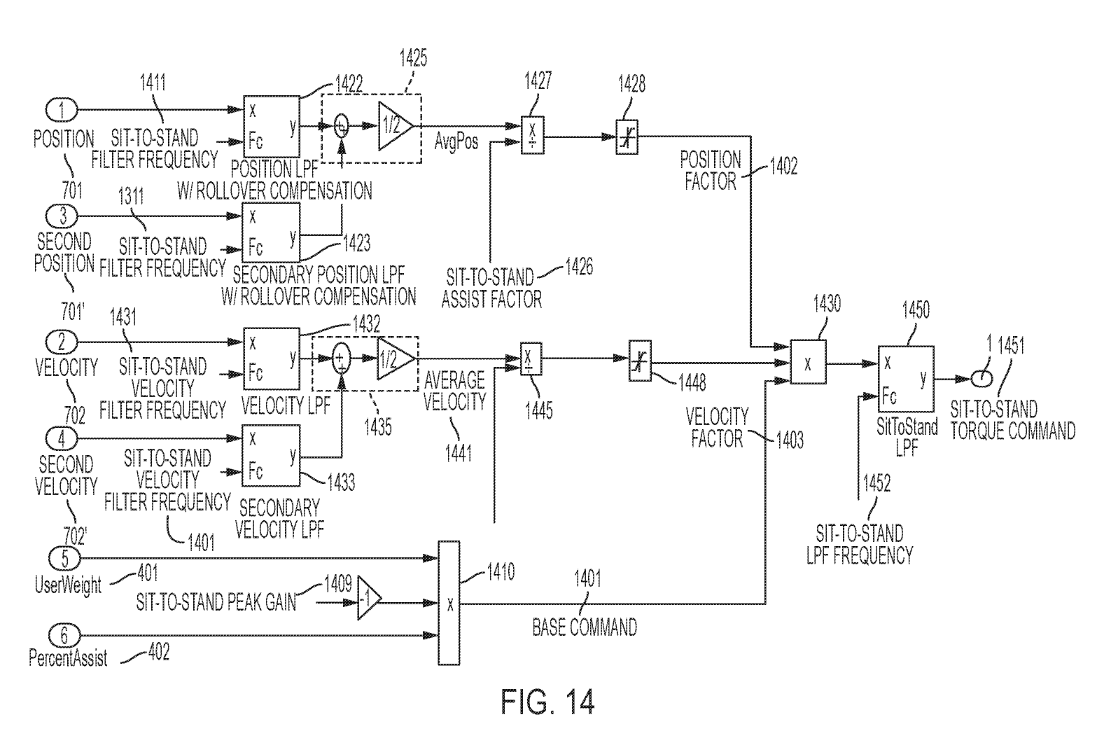

FIG. 14 depicts a block diagram for sit-to-stand assist generation and dynamic torque adjustment according to one or more embodiments. In the sit-to-stand mode, a base command (BaseCmd) 1401 is computed using a multiplier (1410) using the user's weight 401, percent assist 402 factor and a sit-to-stand peak gain 1411 for the sit-to-stand mode.

Further, a position factor 1402 is computed based on a first position 701 of a first joint and a second position 701′ of a second joint of the assistive device 10. In one or more examples, the assistive device 10 includes two ECUs, each ECU is connected to a corresponding position sensor. The corresponding position sensor for an ECU is referred to as the primary position sensor. Secondary position sensor information is transferred through a communication link, such as a CAN bus, from one ECU to the other. For example, for a first ECU, the first position 701 is the primary position, and the second position 701′ is the secondary position; whereas, for a second ECU, the second position is the primary position and the first position is the secondary position. In one or more examples, each ECU corresponds to a hip join. For example, the first ECU is associated with a left leg, and the second ECU is associated with a right leg.

The position factor 1402 is based on an average position 1421 computed using the first position 702 and the second position 701′. The average position 1421 is computed (1425) after filtering the first position 701 and the second position 701′ using low pass filters (1422, 1423). The low pass filters (1422, 1423) use a predetermined sit-to-stand filter value 1411 when filtering the first position 701 and the second position 701′. The average position 1421 is divided (1427) by a predetermined sit-to-stand assist factor 1326 to compute the position factor 1402. The position factor 1402 is saturated (1428) in one or more examples. The position factor 1402 is multiplied (1430) with the base command 1401 and a velocity factor 1403. The result of the multiplication (1430) is used to generate a stand-to-sit torque command 1451.

The velocity factor 1403 is based on average velocity 1441 computed using a first velocity 702 of the first joint and a second velocity 702′ of the second joint. The average velocity 1441 is computed (1435) after filtering the first velocity 702 and the second velocity 702′ using low pass filters (1432, 1433). The average velocity 1441 is divided (1445) with a sit-to-stand velocity assist factor 1438. The result is saturated (1438) in one or more examples to determine the velocity factor 1403.

The position factor 1402 is multiplied (1430) with the base command 1401 and a velocity factor 1403 and the result is filtered (1450) to compute the sit-to-stand torque command 1351. The filtering (1450), in one or more examples, is a low pass filter (LPF) using a sit-to-stand LPF frequency 1452.

Accordingly, in the sit-to-stand mode, the velocity and position are combined as the person needs high assist at the beginning of this mode.

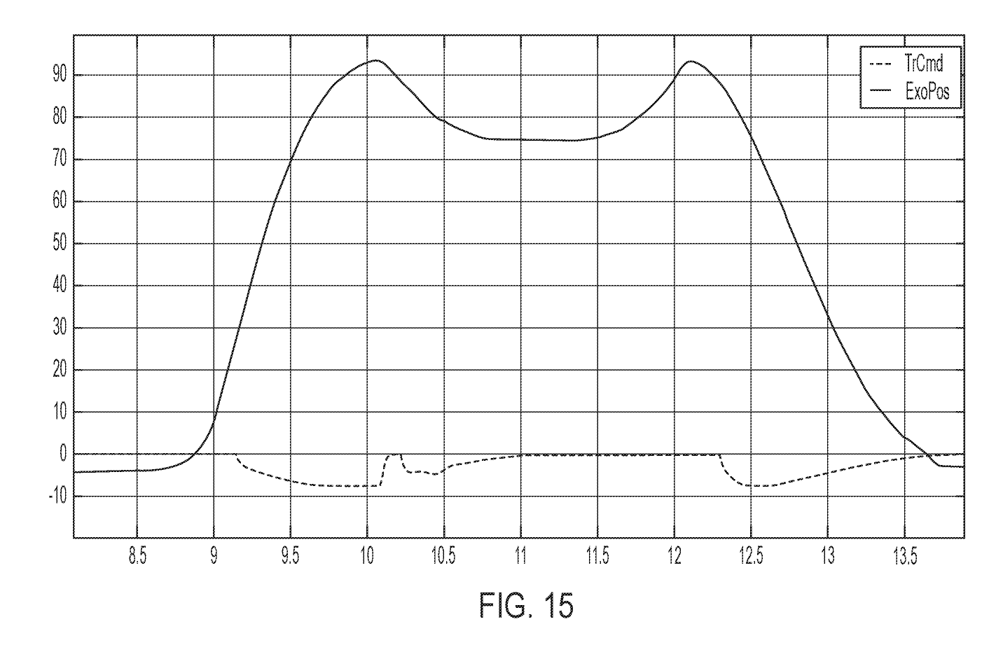

FIG. 15 depicts a controller torque profile for stand-to-sit and sit-to-stand modes according to one or more embodiments.

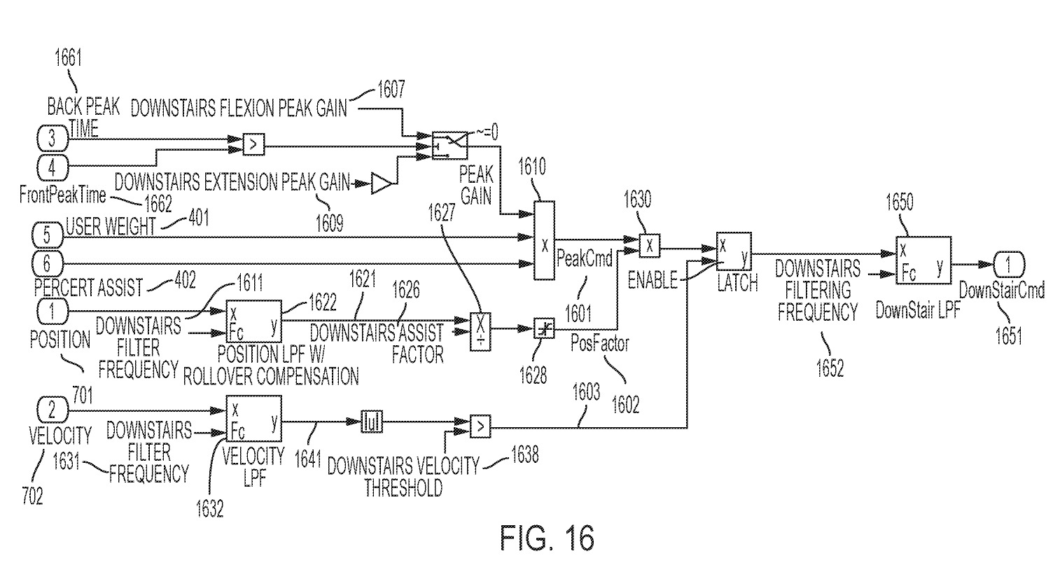

FIG. 16 depicts a block diagram for downstairs assist generation and dynamic torque adjustment according to one or more embodiments. In the downstairs mode, a peak command (PeakCmd) 1601 is computed using a multiplier (1610) using the user's weight 401, percent assist 402 factor and a pair of downstairs peak gains downstairs flexion peak gain 1607 and downstairs extension peak gain 1609 for the downstairs mode. In one or more examples, one of the two gains is selected based on a front time 1661 and a back time 1662. The front time 1661 and the back time 1662 depict a timer value of peak events in the swinging motion of the user's 12 legs during stair climb/descent. FrontPeakTime=Timer value at Peak Flexion Position; BackPeakTime=Timer value at Peak Extension Position. By comparing these values, one or more embodiments detect what part of stair climb/descent the user 12 is in. Different torque amplitude can be used to assist with flexion motion vs. extension motion during stair climb/descent.

Further, a position factor 1602 is computed based on a first position 701 of a first joint of the assistive device 10. The first position 701 is computed after filtering the first position (ExoPos) 701 using low pass filter (1622). The low pass filter (1622) uses a predetermined downstairs filter value 1611 when filtering the first position 701. The position 1621 is divided (1627) by a predetermined downstairs assist factor 1626 to compute the position factor 1602. The position factor 1602 is saturated (1628) in one or more examples. The position factor 1602 is multiplied (1630) with the peak command 1601. The result of the multiplication (1630) is used to generate a downstairs torque command 1651.

The velocity factor 1603 is based on the first joint velocity 702. The velocity 1641 is computed (1635) after filtering the first velocity 702 using low pass filter (1632). The velocity 1641 is compared with a downstairs velocity threshold 1638. The result of the comparison is used as an enabling value (flag) for the multiplication result (1630) to be used to compute the downstairs torque command 1651.

The multiplication result (1630) is filtered (1650) to compute the downstairs torque command 1651. The filtering (1650), in one or more examples, is a low pass filter (LPF) using a downstairs LPF frequency 1652.

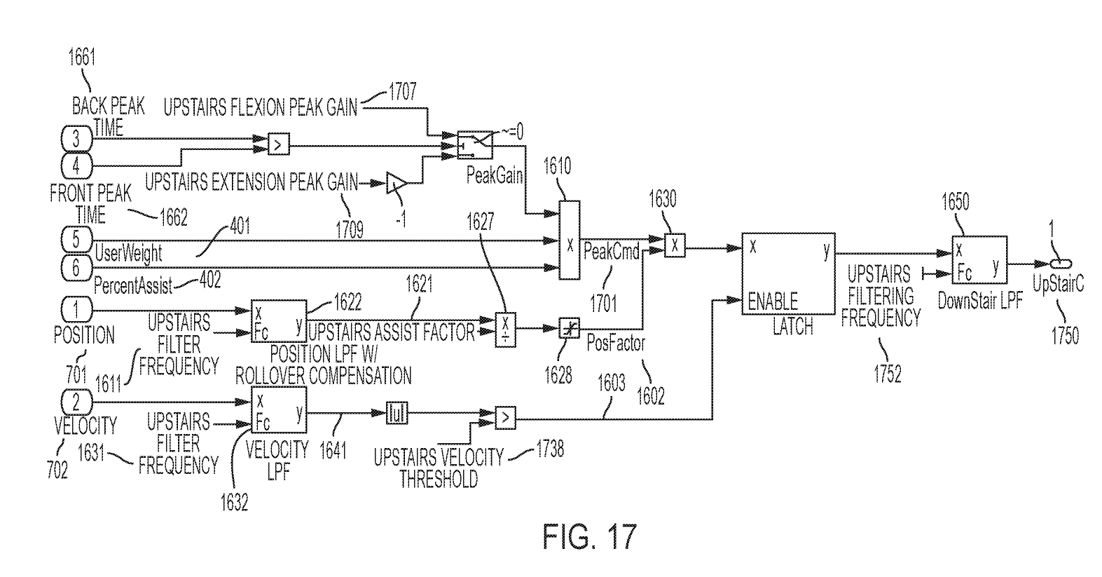

FIG. 17 depicts a block diagram for upstairs assist generation and dynamic torque adjustment according to one or more embodiments. In the upstairs mode, a peak command (PeakCmd) 1701 is computed using a multiplier (1610) using the user's weight 401, percent assist 402 factor and a pair of upstairs peak gains upstairs flexion peak gain 1707 and upstairs extension peak gain 1709 for the upstairs mode. In one or more examples, one of the two gains is selected based on a front time 1661 and a back time 1662 for the upstairs mode.

Further, a position factor 1602 is computed based on a first position 701 of a first joint of the assistive device 10. The first position 701 is computed after filtering the first position (ExoPos) 701 using low pass filter (1622). The low pass filter (1622) use a predetermined upstairs filter value 1611 when filtering the first position 701. The position 1621 is divided (1627) by a predetermined upstairs assist factor 1726 to compute the position factor 1602. The position factor 1602 is saturated (1628) in one or more examples. The position factor 1602 is multiplied (1630) with the peak command 1401. The result of the multiplication (1630) is used to generate an upstairs torque command 1751.

The velocity factor 1603 is based on the first joint velocity 702. The velocity 1641 is computed (1635) after filtering the first velocity 702 using low pass filter (1632). The velocity 1641 is compared with an upstairs velocity threshold 1738. The result of the comparison is used as an enabling value (flag) to for the multiplication result (1630) to be used to compute the downstairs torque command 1751.

Result (1630) is filtered (1650) to compute the upstairs torque command 1751. The filtering (1650), in one or more examples, is a low pass filter (LPF) using an upstairs LPF frequency 1752. The biomechanical assistive device 10 may further detect and operate in standing and sitting modes. In one or more examples, these user activities are defined as activities that do not require torque assistance, therefore no movement is performed for these modes, and accordingly, the net torques are zero.

In one or more examples, the feel of the biomechanical assistive device 10 is configured/adjusted specific to the users 12 for the device 10 to “learn” a standing posture, a sitting (squatting) posture, and other specific movements of the user 12. Other position and velocity based methods such as the ones described here can also be utilized in such activities.

Further yet, the technical solutions described herein (shown in FIG. 1) facilitate an activity recognition that identify the activity being performed by the user based on the sensor signals. Further, in one or more examples, the technical solutions determine the key motion parameters to be collected, based on the recognized activity, and measure and record the parameters so that as to deliver corresponding assistive torque to the user. In one or more examples, the parameters measured and recorded by the assistive device includes gait parameters measured using sensors located on the assistive device that is worn by the user. For example, the sensors measure position, speed, acceleration, force, and the like. Using input from the sensors, a controller determines motion patterns for the user, the motion parameters being stored for further analysis.

It should be noted that although several embodiments herein use the biomechanical assistive device to describe the technical solutions, the technical solutions are not limited to biomechanical assistive devices only. For example, the technical solutions described herein can be used in other types of motion control systems that are used to generate assist torque, such as steering systems for vehicles.

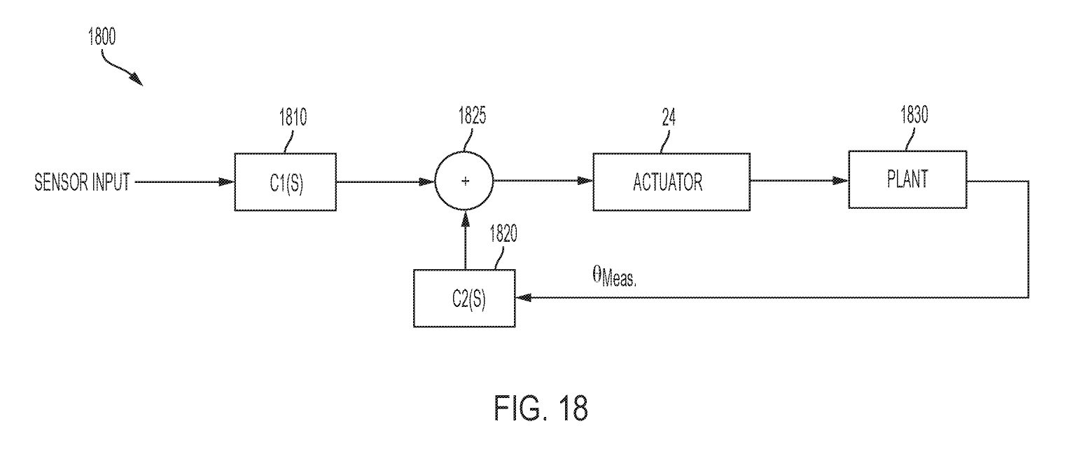

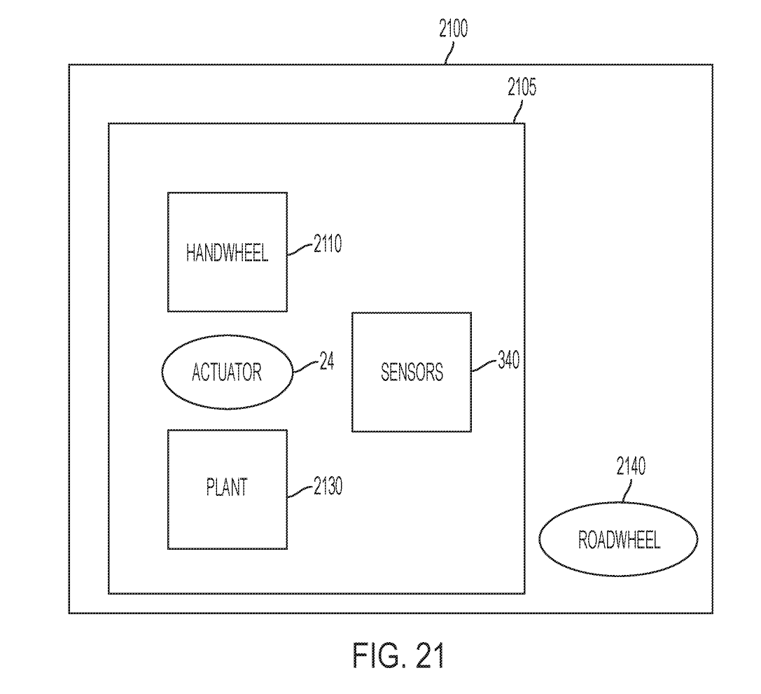

FIG. 18 depicts a block diagram of a control system according to one or more embodiments. The control system 1800 depicted is generalized from the description provided herein. In FIG. 18, a first controller 1810 and a second controller 1820 use the actuator 24 to generate torque and provide it to a mechanical system (plant) 1830. In the specific examples described herein, the plant 1830 can be the biomechanical assistive device 10; in other embodiments, the plant 1830 can be a steering system of a vehicle (FIG. 21).

The first controller 1810 receives sensor measurements as input and computes an oscillation frequency of the plant 1830 based on the sensor inputs. For example, the sensor input can include position, force, electromyography (EMG), sound, image(s) from a camera, and the like.

For example, an input position of a user of the plant 1830 is measured when the user 12 moves when s/he is wearing the assistive device 10, and the position of the user's joint(s) can be the input positions. In case of a steering system, position (angle) of a handwheel or any other input device of the steering system is the input position to the control system 1800. The first controller generates a torque command for the actuator so as to generate assist torque for the user to complement/supplement the effort(s) being applied by the user 12 to use the overall system of which the control system 1800 is a part.

Measurements from the plant 1830 are received by the second controller 1820 as feedback. The measurements can include one or more sensor measurements, such as position, current, voltage, and the like. As described herein, only the position signal can be used for several applications described herein, reducing the number of sensors used in the overall system because of the technical solutions described herein. The second controller 1830 creates/adjusts a torque command that is being sent to the actuator for creating the assist torque. In one or more examples, the two controllers 1810 and 1820 can generate separate torque commands (first torque command, second torque command).

Accordingly, the first controller 1810 provides a “predictive” torque command based on actions of the user and/or external inputs to the system 1800; the second controller 1820 provides a “reactive” torque command based on feedback from the plant 1830. The two torque commands are blended (e.g. added) 1825 before forwarding to the actuator 24. Other types of blending can be performed in other embodiments. For example, in one example, only one of the two torque commands is used, in which case the “blending” includes selecting one of the torque commands from the two controllers 1810 and 1820, and forwarding the selected torque command for generating the assist torque. The selection can be based on one or more parameters and/or calculations. For example, as described herein, in case of the assistive device 10, the stride frequency confidence is used as a deciding factor of whether to use the reactive torque command or the predictive torque command.

The predictive torque command can be based on one or more controller torque profiles for the user 12. For example, depending on what type of an activity the user is performing, a specific controller torque profile for that activity can be used to generate the predictive torque command based on the input position. The reactive torque command is generated without such a controller torque profile, rather using one or more feedback techniques such as using a state observer, a proportional-integrative (PI) controller, a PI-derivative (PID) controller, and the like or any combination thereof. The control system 1800 accordingly provides a 2 degree of freedom type control.

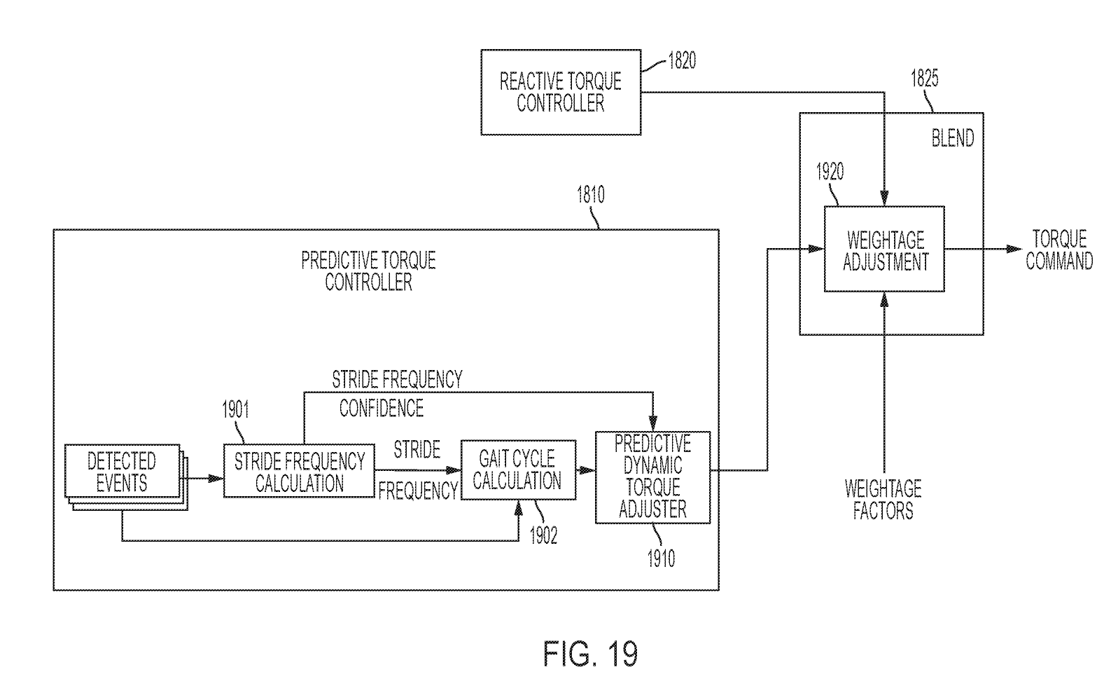

FIG. 19 depicts an operation flow diagram for blending a reactive torque command a predictive torque command according to one or more embodiments. As depicted, both, a predictive torque controller 1810 and a reactive torque controller 1820, generate corresponding predictive torque command and reactive torque command.

The predictive torque command is based on the controller torque profile(s) and the reactive torque command on one or more sensor inputs from the plant 1830 (FIG. 18). The predictive torque controller 1810 uses detected events to compute a stride frequency (1901) and gait cycle (1902). The computation can include determining the one or more parameters including step length, stride length, and other such parameters associated with the user's 12 movement described herein. A predictive torque command is computed (1902) based on the gait cycle. The predictive torque command is further adjusted (1910) based on the stride frequency confidence that is calculated as described herein. The adjustment can include scaling (up/down) the predictive torque command based on the stride frequency confidence.

Further, the blend module 1825 computes (1920) a final torque command based on the predictive torque command and the reactive torque command. In the depicted example, the final torque command is computed as a weighted average/sum of the predictive torque command (after adjustment) and the reactive torque command. The weightage can be predetermined. Alternatively, or in addition, the weightage can be dynamically adjusted using a stride frequency, the stride frequency confidence or any other parameters. The final torque command is then applied to the actuator 24 to generate corresponding amount of assist torque.

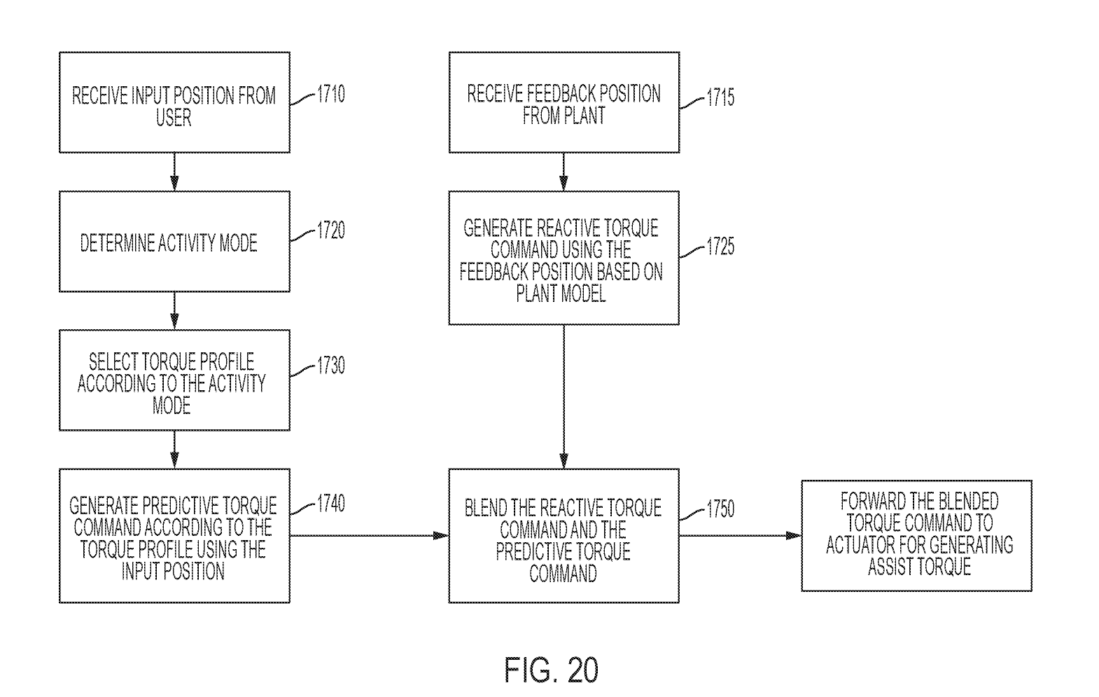

FIG. 20 depicts a flowchart of an example operation of the control system according to one or more embodiments. The method includes the first controller 1810 receiving the input position signal at 1710. The position signal can be received from one or more position sensors 340. Further, the method includes the first controller 1810 detecting an activity that the user 12 is performing at 1720. In case of the assistive device 10, the activity can be walking, sit-to-stand, stand-to-sit, sitting, standing, and the like. The activity detection can be automatic as described herein. The activity can be something different in case of the plant 1630 being another system; for example, in case of a steering system, the activity can be maneuvering the vehicle on particular type of road surface (slippery, rough), parking maneuvers, and the like.

The controller 1810 further selects a controller torque profile according to the activity that is detected at 1730. The controller torque profile provides the controller 1810 an amount of torque to be provided as assist torque for the particular activity being performed. The controller torque profile can further be specific to the user 12. For example, the user's weight, height, and other such factors can be taken into account when predicting the assist torque for the user 12 in case of the assistive device 10. In case of the steering system, factors such as the coefficient of friction, vehicle speed, and the like can be taken into account by the controller torque profile when determining the amount assist torque to be provided. The first controller 1810 generates the predictive torque command based on the received input position signal and according to the selected controller torque profile at 1740.

Concurrently, the second controller 1820 receives feedback from the plant 1830 at 1715. The feedback can include position signal of one or more mechanical components of the plant 1830. For example, in case of the assistive device 10, position(s) of one or more joints in the assistive device 10 can be measured by position sensor(s) and received as the feedback. In case of the steering system, the feedback can include a position of a rack moved by the steering system. Alternatively, or in addition, the feedback can include position of a roadwheel.

The second controller 1820 generates reactive torque command based on the feedback received and using a plant model at 1725. The reactive torque command can be based on further moving the components of the plant 1830 to a desired position.

The method further includes blending the predictive torque command from the first controller 1810 and the reactive torque command from the second controller 1820 at 1750. The blending can include adding the two torque commands together and limiting the torque command to a predetermined maximum value. Alternatively, or in addition, the blending can include a weighted sum of the two torque commands. In one or more examples, the weighting can be dynamic, where the weights or proportions assigned to the two torque commands is determined at runtime.

For example, in case of the assistive device 10, the weighting can be based on a stride frequency confidence value (SFC). For example, the final torque command is computed as Final Torque=SFC*Predictive Torque+(1−SFC)*Reactive Torque. Other weighting schemes than the above example can be used in other embodiments.

The blended torque command is forwarded to the actuator 24 to generate the corresponding amount of torque as assist torque to be applied to the plant 1830. The method can be continually performed in this manner.

FIG. 21 depicts an example block diagram of a vehicle that includes a steering system implementing one or more embodiments described herein. FIG. 21 depicts a vehicle 2100 that includes a steering system 2105. The steering system 2105 can include a handwheel 2110, an actuator 24, one or more sensors 340, and a plant 2130. The plant 2130 can include mechanical/electrical components that facilitate the handwheel 2110 to cause one or more road wheels 2140 of the vehicle 2100 to be maneuvered. It is understood that the vehicle 2100 can include various other parts than those depicted in FIG. 21.

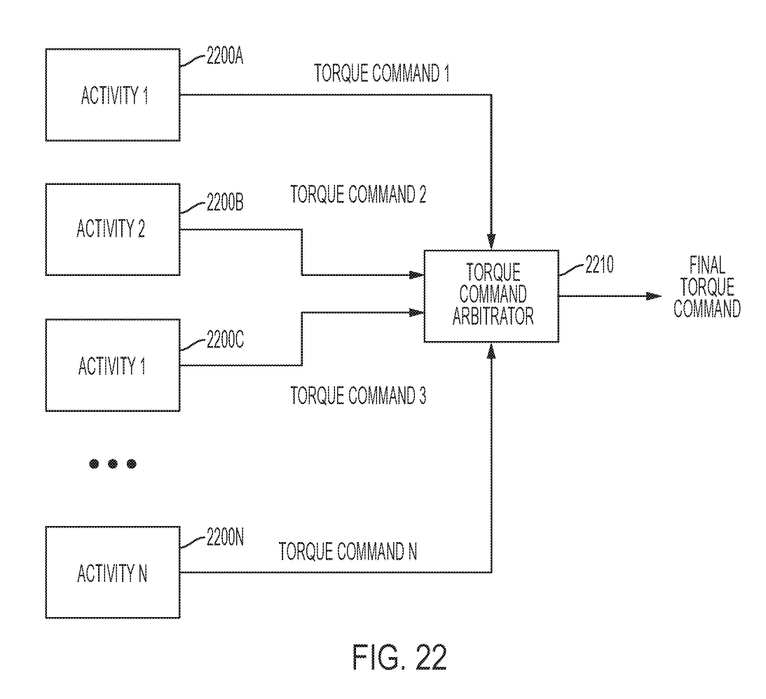

FIG. 22 depicts a block diagram for generating a torque command in a system according to one or more embodiments. In the depicted example system, several activities 2200 (A-N) are detected and an assist torque for each of them can be generated. The system can include separate modules for generating the assist torque for each of the activities 2200. For example, in case of the assistive device 10, the activities 2200 can include walking, stand-to-sit, sit-to-stand, sitting, standing, stair accent, stair descent, and the like. In one or more examples, the activities 2200 can further include a limiting function, which if setup, limits the operation space of the device 10 within a selected position range. For example, the limiting activity can be used to limit the torque assist provided to a single leg, in a particular direction, and the like. Each separate module for each respective activity 2200 generates a corresponding torque command for providing assist torque for particular activity.

A torque arbitrator 2210 arbitrates between the torque commands that have been generated based on the activities 2200 and ensures that a smooth transition is established from one activity to another. The arbitrator 2210 can define a priority of activities 2200 to support if there are conflicting torque commands, for example a torque command from the walking activity (say 2200A) and the stand-to-sit activity (say 2200C). In one or more examples, the arbitrator 2210 can limit a change in successive torque commands so that the assist torque generated by the actuator 24 does not vary beyond a predetermined limit within a predetermined duration of time. This prevents the user 12 from experiencing sudden jerks of assist torque from the assistive device, and a smoother transition from one activity to another.

Accordingly, the assistive device 10 can provide assist torque for multiple activities 2200 and further a transition from one activity to another can be handled without sudden jerks.

While the technical solutions has been described in detail in connection with only a limited number of embodiments, it should be readily understood that the technical solutions are not limited to such disclosed embodiments. Rather, the technical solutions can be modified to incorporate any number of variations, alterations, substitutions or equivalent arrangements not heretofore described, but which are commensurate with the spirit and scope of the technical solutions. Additionally, while various embodiments of the technical solutions have been described, it is to be understood that aspects of the technical solutions may include only some of the described embodiments. Accordingly, the technical solutions are not to be seen as limited by the foregoing description.

What is claimed is:

1. A biomechanical assistive device configured to generate and provide assist torque by detecting user intent, the biomechanical assistive device comprising:
a motor; and
a controller that is configured to:
generate a torque command for providing assist torque using the motor based on a user activity being performed using the biomechanical assistive device;
determine a stride frequency based on a position signal indicative of a position of a joint of the biomechanical assistive device;
dynamically adjust the torque command based on the stride frequency to generate a final torque command; and
apply the final torque command to the motor.

2. The biomechanical assistive device of claim 1, wherein the controller is further configured to:
detect a heel strike and compute, in response, a heel strike limiting factor; and
further modify the torque command using the heel strike limiting factor.

3. The biomechanical assistive device of claim 1, wherein dynamically adjusting the torque command is a reactive dynamic torque adjustment based on a velocity computed using the position signal.

4. The biomechanical assistive device of claim 1, wherein dynamically adjusting the torque command is based on a ground speed and gait cycle.

5. The biomechanical assistive device of claim 1, wherein the position signal is obtained from a position sensor associated with the joint.

6. The biomechanical assistive device of claim 1, wherein the position signal is an estimate computed from a velocity sensor associated with the joint.

7. The biomechanical assistive device of claim 1, wherein the torque command is further based on one or more characteristics of a user that is wearing the biomechanical assistive device.

8. A computer program product for operating a biomechanical assistive device, the computer program product comprising computer readable storage medium with computer executable instructions therein, the computer executable instructions cause a controller to:
generate a torque command for providing assist torque using a motor based on a user activity being performed using the biomechanical assistive device;
determine a stride frequency based on a position signal of a joint of the biomechanical assistive device;
dynamically adjust the torque command based on the stride frequency to generate a final torque command; and
apply the final torque command to the motor.

9. The computer program product of claim 8, wherein the controller is further configured to:
detect a heel strike and compute, in response, a heel strike limiting factor; and
further modify the torque command using the heel strike limiting factor.

10. The computer program product of claim 8, wherein dynamically adjusting the torque command is a reactive dynamic adjustment based on a velocity computed using the position signal.

11. The computer program product of claim 8, wherein dynamically adjusting the torque command is based on a ground speed and gait cycle.

12. The computer program product of claim 8, wherein the position signal is obtained from a position sensor associated with the joint.

13. The computer program product of claim 8, wherein the position signal is an estimate computed from a velocity sensor associated with the joint.

14. The computer program product of claim 8, wherein the torque command is further based on one or more characteristics of a user that is wearing the biomechanical assistive device.

15. A computer-implemented method for operating a biomechanical assistive device, the computer-implemented method comprising:
generating a torque command for providing assist torque using a motor based on a user activity being performed using the biomechanical assistive device;
determining a stride frequency based on a position signal of a joint of the biomechanical assistive device;
dynamically adjusting the torque command based on the stride frequency to generate a torque command; and
applying the torque command to the motor.

16. The computer-implemented method of claim 15, further comprising:
detecting a heel strike and compute, in response, a heel strike limiting factor; and
modifying the torque command using the heel strike limiting factor.

17. The computer-implemented method of claim 15, wherein dynamically adjusting the torque command is a reactive dynamic adjustment based on a velocity computed using the position signal.

18. The computer-implemented method of claim 15, wherein dynamically adjusting the torque command is based on a ground speed and gait cycle.

19. The computer-implemented method of claim 15, wherein the position signal is an estimate computed from a velocity sensor associated with the joint.

20. The computer-implemented method of claim 15, wherein the torque command is further based on one or more characteristics of a user that is wearing the biomechanical assistive device.
